(19) United States
(12) Patent Application Publication
(10) Pub. No.: US 2024/0400073 A1
(43) Pub. Date: Dec. 5, 2024

(54) RULE BASED LANE TOUCH ANALYSIS FOR AUTOMATED DRIVING

(71) Applicant: GM Global Technology Operations LLC, Detroit, MI (US)

(72) Inventors: Shengbing Jiang, Rochester Hills, MI (US); Zifeng Peng, Rochester Hills, MI (US); Xinyu Du, Oakland Township, MI (US); Jingyan Wan, Sterling Heights, MI (US)

(21) Appl. No.: 18/327,704

(22) Filed: Jun. 1, 2023

(51) Int. Cl. B60W 50/029; B60W 50/02

(52) U.S. Cl. CPC B60W 50/029; B60W 50/0205; B60W 2050/021

(57) ABSTRACT

A system for designing a driving system for a vehicle. The system includes a first sensor, a second sensor and a processor. The first sensor is configured to obtain an external parameter indicative of a lane marking during a time period in which an automated driving program is being operated at the vehicle. The second sensor is configured to obtain an internal parameter of the vehicle during the time period. The processor is configured to detect a lane touch event occurring during the time period, determine an error occurring in the driving system resulting in the lane touch event based on the internal parameter and the external parameter, identify a failure domain of the driving system in which the error occurs, and change a design of a program of the driving system related to the failure domain.

### INTRODUCTION

The subject disclosure relates to operation of an autonomous vehicle or a cruise control system of a vehicle and, in particular, to a system and method for analyzing an occurrence of a lane touch event to identify a failure domain of a guidance system of the vehicle that leads to the lane touch.

An autonomous vehicle as well as a vehicle operating in a super cruise control mode can operate a guidance system that allows the vehicle to move safely along a section of road. The guidance system maintains the vehicle within a lane indicated by lane markings. A lane touch event occurs when the vehicle touches or crosses over a lane marking or veers outside of its lane. For safety reasons, it is desired to minimize or eliminate the occurrence of inadvertent lane touch events. When a lane touch event occurs during automated operation of the vehicle, it is desired to determine its cause so that the guidance system can be upgraded or redesigned. Currently, determining the cause of a lane touch requires an engineering team to manually review data, which is time consuming and subjective. Accordingly, it is desirable to provide a system that can determine a cause for the occurrence of a lane touch event, in order to aid in designing and improving guidance systems.

### SUMMARY

In one exemplary embodiment, a method of operating a driving system for a vehicle is disclosed. An external parameter indicative of a lane marking is obtained using a first sensor during a time period in which an automated driving program is being operated at the vehicle. An internal parameter of the vehicle is obtained using a second sensor during the time period. A lane touch event occurring during the time period is detected. An error occurring at the driving system resulting in the lane touch event is determined at a processor based on the internal parameter and the external parameter. A failure domain of the driving system in which the error occurs is determined at the processor. A design of a program of the driving system related to the failure domain is changed.

In addition to one or more of the features described herein, each of the internal parameter and the external parameter includes a time series of data obtained over a time interval. The failure domain is at least one of a vehicle sensing domain, a path planning domain, a vehicle control domain, and a reporting domain. An error in the vehicle sensing domain includes an error in detecting a lane marking. The method further includes determining an error in the path planning domain when a lane touch occurs by comparing a difference between a planned path of the vehicle to an actual path of the vehicle to a threshold value. The method further includes determining a lane change issue due to one of a late abort of a lane change, oversteering during a lane change, and an over adjustment for the lane change. The method further includes determining a responsiveness of the driving system to the lane touch event.

In another exemplary embodiment, a driving system for a vehicle is disclosed. The driving system includes a first sensor, a second sensor and a processor. The first sensor is configured to obtain an external parameter indicative of a lane marking during a time period in which an automated driving program is being operated at the vehicle. The second sensor is configured to obtain an internal parameter of the vehicle during the time period. The processor is configured to detect a lane touch event occurring during the time period, determine an error occurring in the driving system resulting in the lane touch event based on the internal parameter and the external parameter, identify a failure domain of the driving system in which the error occurs, and change a design of a program of the driving system related to the failure domain.

In addition to one or more of the features described herein, each of the internal parameter and the external parameter includes a time series of data obtained over a time interval. The failure domain is at least one of a vehicle sensing domain, a path planning domain, a vehicle control domain, and a reporting domain. An error in the vehicle sensing domain that includes an error in detecting a lane marking. The processor is further configured to determine an error in the path planning domain when a lane touch occurs by comparing a difference between a planned path of the vehicle to an actual path of the vehicle to a threshold value. The processor is further configured to determine a lane change issue due to one of a late abort of a lane change, oversteering during a lane change, and an over adjustment for the lane change. The processor is further configured to determine a responsiveness of the driving system to the lane touch event.

In yet another exemplary embodiment, a system for designing a driving system for a vehicle is disclosed. The system includes a first sensor, a second sensor and a processor. The first sensor is configured to obtain an external parameter indicative of a lane marking during a time period in which an automated driving program is being operated at the vehicle. The second sensor is configured to obtain an internal parameter of the vehicle during the time period. The processor is configured to detect a lane touch event occurring during the time period, determine an error occurring in the driving system resulting in the lane touch event based on the internal parameter and the external parameter, identify a failure domain of the driving system in which the error occurs, and change a design of a program of the driving system related to the failure domain.

In addition to one or more of the features described herein, the failure domain is at least one of a vehicle sensing domain, a path planning domain, a vehicle control domain, and a reporting domain. An error in the vehicle sensing domain that includes an error in detecting a lane marking. The processor is further configured to determine an error in the path planning domain when a lane touch occurs by comparing a difference between a planned path of the vehicle to an actual path of the vehicle to a threshold value. The processor is further configured to determine a lane change issue due to one of a late abort of a lane change, oversteering during a lane change, and an over adjustment for the lane change. The processor is further configured to determine a responsiveness of the driving system to the lane touch event.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle that can be operated in an autonomous mode or in a cruise control mode, in accordance with an exemplary embodiment;

FIG. 2 is a schematic diagram showing an operational flow for analyzing and improving a driving system with respect detecting lane markings and moving with respect to the lane markings;

FIG. 3 shows a schematic diagram showing various programs operating at the driving system to steer the vehicle along a trajectory, in an illustrative embodiment;

FIG. 4 shows a schematic diagram that identifies failure domains for the programs of the driving system;

FIG. 5 shows a plurality of time series that can be analyzed at the remote processor to identify a failure domain;

FIG. 6 shows a flowchart of a method for identifying a reason for a lane touch occurrence, in an illustrative embodiment;

FIG. 7 shows a flowchart for identifying a lane mark detection issue, in an illustrative embodiment;

FIG. 8 shows a flowchart of a method for identifying path planning issues;

FIG. 9 shows a flowchart of a method for identifying lane change issues; and

FIG. 10 shows a flowchart of a method for identifying straight road issues.

### DETAILED DESCRIPTION

The following description is merely exemplary in nature and is not intended to limit the present disclosure, its application or uses. It should be understood that throughout the drawings, corresponding reference numerals indicate like or corresponding parts and features.

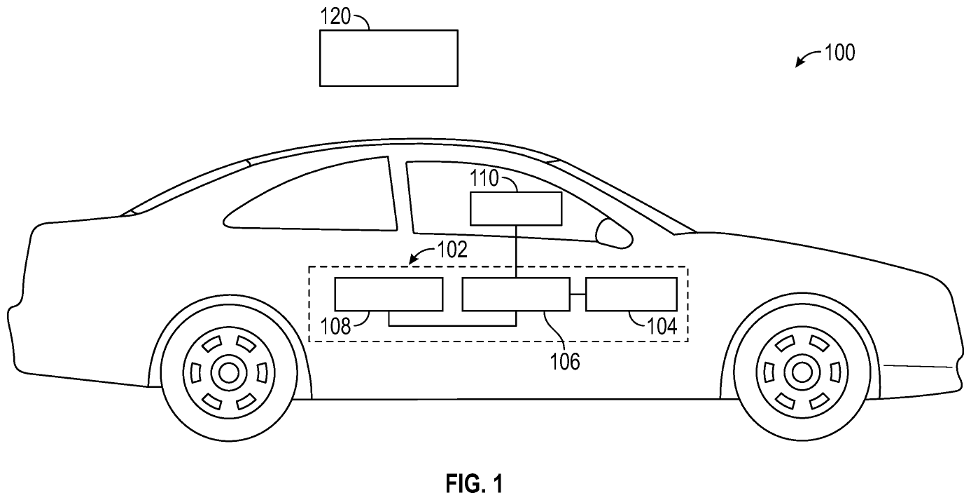

In accordance with an exemplary embodiment, FIG. 1 shows a vehicle 100 that can be operated in an autonomous mode or in a cruise control mode. The vehicle 100 includes a driving system 102 that controls motion of the vehicle along a section of road.

The driving system 102 can include a sensor system 104 for obtaining information about the surrounding or environment of the vehicle 100 or of the vehicle itself, a controller 106 for computing possible actions for the autonomous vehicle based on the obtained information and for implementing one or more of the possible actions, and an actuator system 108 that controls navigation of the vehicle, such as a steering wheel actuator, brakes actuator, acceleration actuator, etc., based on action calculated at the controller 106.

The sensor system 104 can include external sensors (first sensors) such as cameras, Lidar, radar, GPS, etc., that measure various external parameters of the environment, the road, the location of lane markers, etc. The sensor system 104 can also include internal sensors (second sensors) that measure internal parameters of the vehicle, such as an accelerometer, an angle measuring device, etc. The data obtained for a given parameter, either internal or external, can be obtained as a time series. Exemplary parameters include a road curvature, a distance between the vehicle and lane and right lanes or left and right lane markers, vehicle speed, a yaw rate of the vehicle, a lateral acceleration of the vehicle, a longitudinal acceleration of the vehicle, a vehicle location, a steering wheel angle (SWA), steering torque, an LCOD (lane change on demand) status, and/or an LCC (lane centering control) status, etc.

The controller 106 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 106 may include a non-transitory computer-readable medium that stores instructions which, when processed by one or more processors of the controller 106, implement a method of analyzing parameters obtained by the sensor system 104, determine an occurrence of a lane touch event, determine a root cause or a failure domain for the lane touch event, and suggest possible improvements to mitigate the occurrence of a lane touch event in the future.

The vehicle 100 also include a communication unit 110 that can communicate with a remote processor 120. In various embodiments, data can be transferred from the vehicle 100 to the remote processor 120 for offboard processing. Data or software can also be transferred from the remote processor 120 to the vehicle 100.

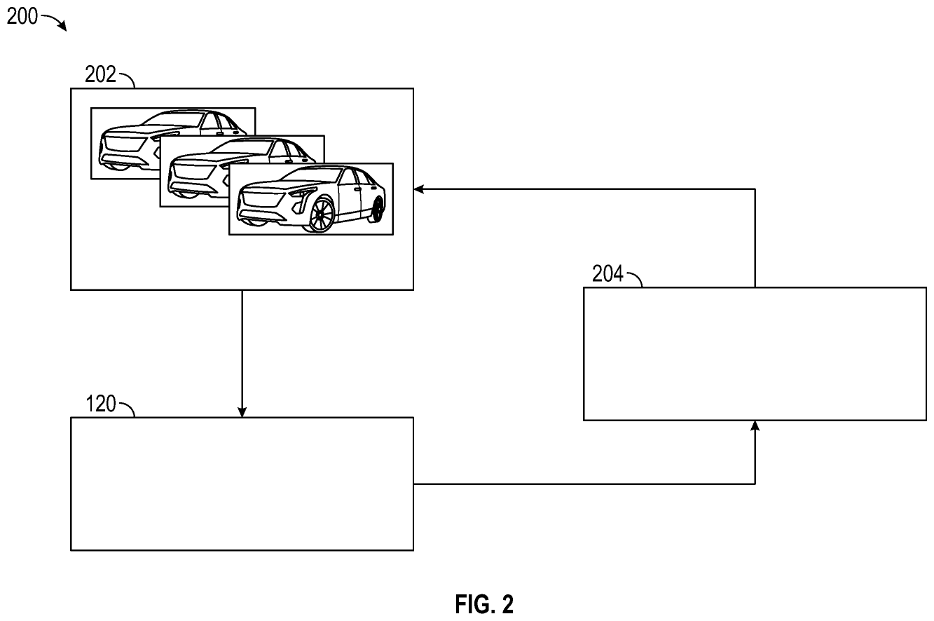

FIG. 2 shows a schematic diagram 200 showing an operational flow for analyzing and improving a driver system 102 with respect detecting lane markings and moving with respect to the lane markings. The operational flow includes calculations that are performed either on board the vehicle 100 using a processor (such as at the controller 106) of the vehicle 100 or off board of the vehicle using the remote processor 120. A fleet of vehicles 202 is driven in various environments to obtain data in the form of a plurality of time series data. The plurality of time series data is sent to the remote processor 120, which analyzes the time series data to determine when a lane touch occurs and a cause for the lane touch. In particular, the remote processor 120 determines a domain in which an error occurs that results in the lane touch. A lane touch event can occur due to a failure in multiple domains. Exemplary errors include, but are not limited to, an error in lane perception, an error in path planning, an error in steering, etc. When a lane touch event occurs, the remote processor 120 determines in which domain (“the failure domain”) the error occurs that results in the lane touch event. The analysis results in a recommendation for review and/or design improvements of the failure domain, which design improvements can be implemented and used back at the fleet of vehicles 202. If the analysis is unable to identify a failure domain, a new (unknown class) domain can be created and used in subsequent analyses.

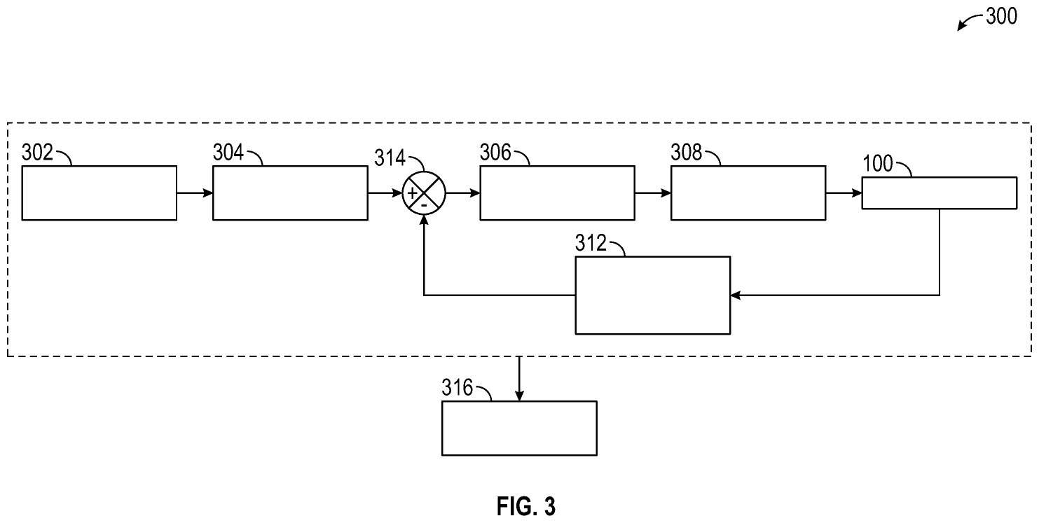

FIG. 3 shows a schematic diagram 300 showing various programs operating at the driving system 102 to steer the vehicle along a trajectory, in an illustrative embodiment. The programs include a perception model 302, a path planning model 304, a vehicle tracking controller 306, a steering controller 308 and a vehicle location sensing/estimation program 312. The perception model 302 determines the presence and location of lane markings from the data obtained by the sensing system 104. The data can be related to weather conditions, road conditions, wind conditions, road slope, etc. The path planning model 304 is an algorithm or model for planning a trajectory of the vehicle based on the location of the lane markings. The trajectory can include moving in a straight line, taking curves, changing lanes, merging, taking an exit from a freeway, turning at an intersection, etc. The tracking controller 306 receiving input indicating a deviation of the path of the vehicle form a planned trajectory and determines actions that can be taken at the vehicle to make corrections in order to keep the vehicle moving along the planned trajectory. The tracking controller 306 sends signals to the steering controller 308 which determines a steering torque or steering angle to be applied to a steering wheel of the vehicle 100 via the actuators 108.

The vehicle location sensing/estimation program 312 tracks the location of the vehicle 100 in response to the steering signals being applied at the vehicle. The vehicle location can be a lateral location of the vehicle within a lane or with respect to a lane marker. The vehicle location is sent to a difference machine 314 which determines the path deviation based on the vehicle location and the planned trajectory. The path deviation can then be sent to the tracking controller 306 to create a feedback loop.

A lane touch event monitor 316 obtains data from the programs of the driving system 102 and analyzes the data to determine when a lane touch event occurs. Further analysis can determine the root cause of the lane touch event, which can lead to improvements and redesign.

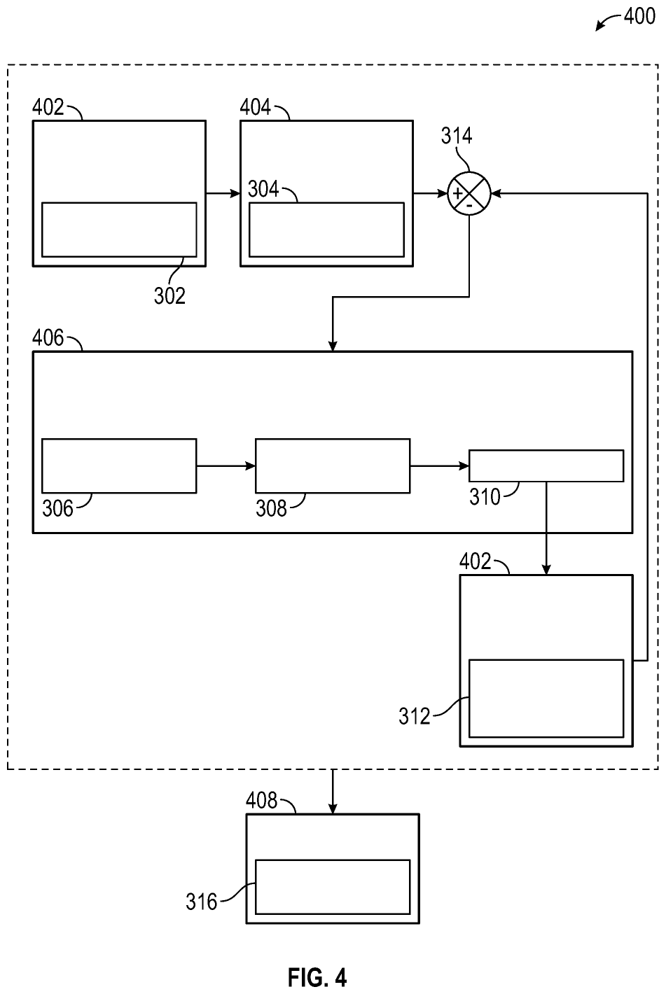

FIG. 4 shows a schematic diagram 400 that identifies failure domains for the programs of the driving system 102. The schematic diagram 400 includes a vehicle sensing domain 402, a path planning domain 404, a vehicle control domain 406, and a reporting domain 408. The vehicle sensing domain 402 includes the perception model 302 and the vehicle location sensing/estimation program 312. The path planning domain 404 includes the path planning model 304. The vehicle control domain 406 includes the tracking control program 306 and the steering control program 308. The reporting domain includes a lane touch event monitor 316.

An error occurring in the vehicle sensing domain 402 can be due to lane marking issues, such as vague lane markings, old and new lane markings, changes in a road color, the occurrence of a road split or a road merge. An error can also occur due to Global Positioning Satellite (GPS) errors, or map errors, poor perception due to weather, time of day, surroundings, etc., or the failure of a sensor.

An error occurring in the path planning domain 404 can be due to a road split or a road merge, the occurrence of a construction zone, an occurrence of other objects (i.e., vehicles, pedestrians) in the road which are nearby or cut from a field of view, etc. The error can also be a result of a ghost object detection, or incorrectly identifying a location of an object.

An error occurring in the vehicle control domain 406 can occur in the vehicle tracking controller 306 and/or the steering controller 308. The error can be caused by control change errors, weather-related control errors, vehicle degradation errors. A control change error occurs at a transition point between human control and vehicle control. The control change error can be due to operation of a lane change on demand (LCOD) program or due to manual lane change. Errors are likely to occur where there is a sharp curve, a zig-zag road, a path change, etc. Weather related control errors, can be errors due to a side wind, rain, snow, a slippery road, a bumpy road, a pothole, a road, a road slope, a bank angle, etc. Vehicle degradation errors can include errors due to tire pressure, wheel misalignment, suspension, uneven braking, uneven propulsion at the wheels, differential propulsion, steering sensor errors, actuator faults, etc.

An error occurring in the reporting domain 408 is due to a malfunction of the lane touch event monitor 316. Such errors can be due to a data collection issue, an onboard memory issue, and electronic control unit issue, a misattribution of the lane touch to a vehicle control (rather than manual control) and other false positives due to a wrong lane mark detection.

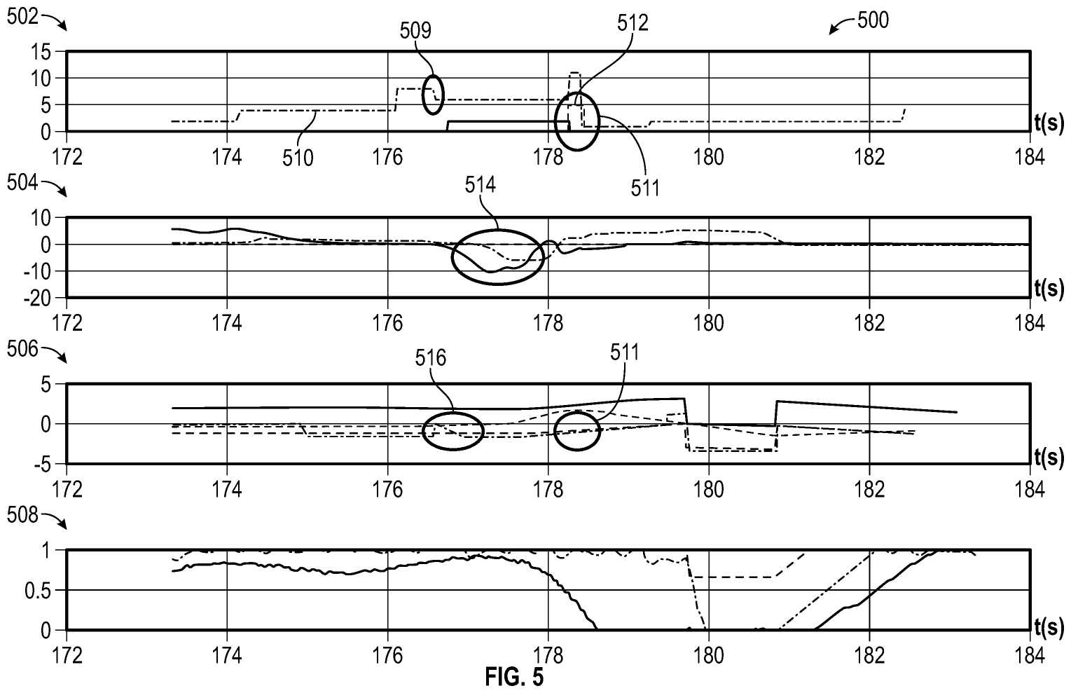

FIG. 5 shows a plurality of time series 500 that can be analyzed at the remote processor 120 to identify a failure domain. For each time series, time is shown in seconds along the abscissa. A first time series 502 includes data related to engaging the super cruise 509 of the vehicle 100 and an occurrence of a lane touch event 511. A second time series 504 includes data related to a steering and road curve. A third time series 506 includes data related to lane offset. A fourth time series 508 includes data related to operation of the lane touch event monitor 316. In the first time series 502, a super cruise curve 510 indicates that the super cruise is engaged at about t=176.5 seconds, and a lane event curve 512 indicates that a lane touch occurs at about t=178.3 second. In the second time series 504, a steering angle (SWA) curve 514 indicates the steering wheel steering to the left briefly at about t=177.0 seconds. In the third time series 506, a distance to target lane curve 516 indicates a quick motion of the vehicle to the left at about t=176.5 seconds. The occurrence of the lane touch event 511 is also shown.

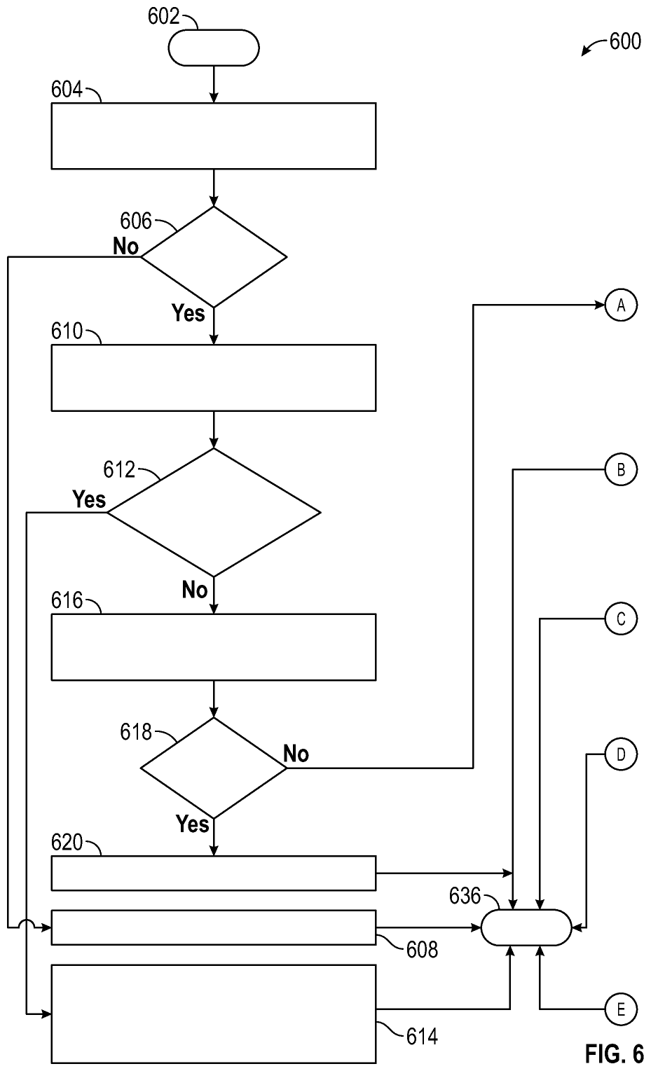

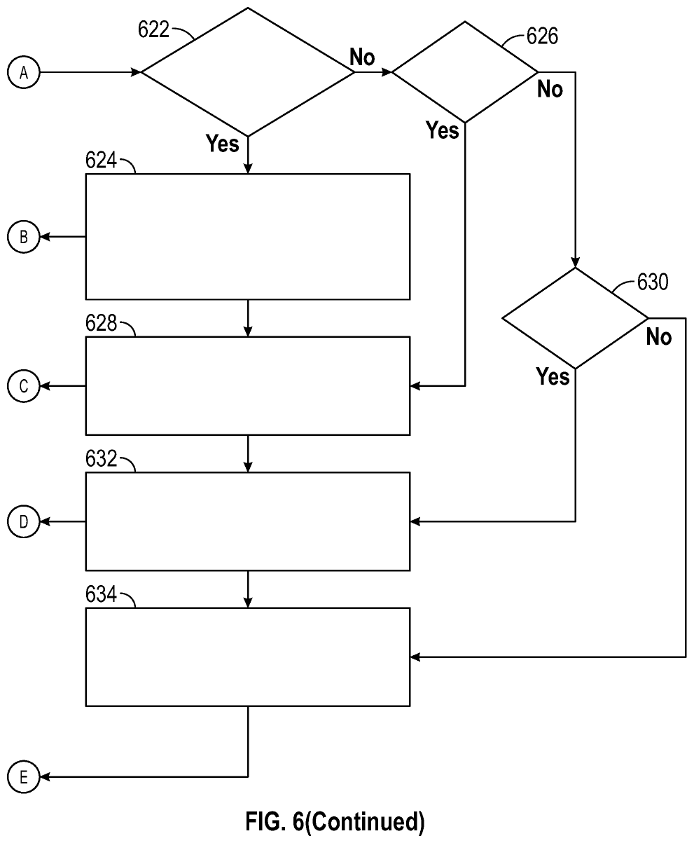

FIG. 6 shows a flowchart 600 of a method for identifying a reason for a lane touch occurrence, in an illustrative embodiment. The method begins at box 602 in which a lane touch report is received. In box 604, the lane touch report is cross-checked against left lane and right lane offsets to determine the integrity of the report. In box 606, a decision is made based on the results of the cross-check in box 604. If the report is not an accurate report, the method proceeds to box 608. In box 608, an output is generated indicating a report error. The method then proceeds to box 636 at which the method ends.

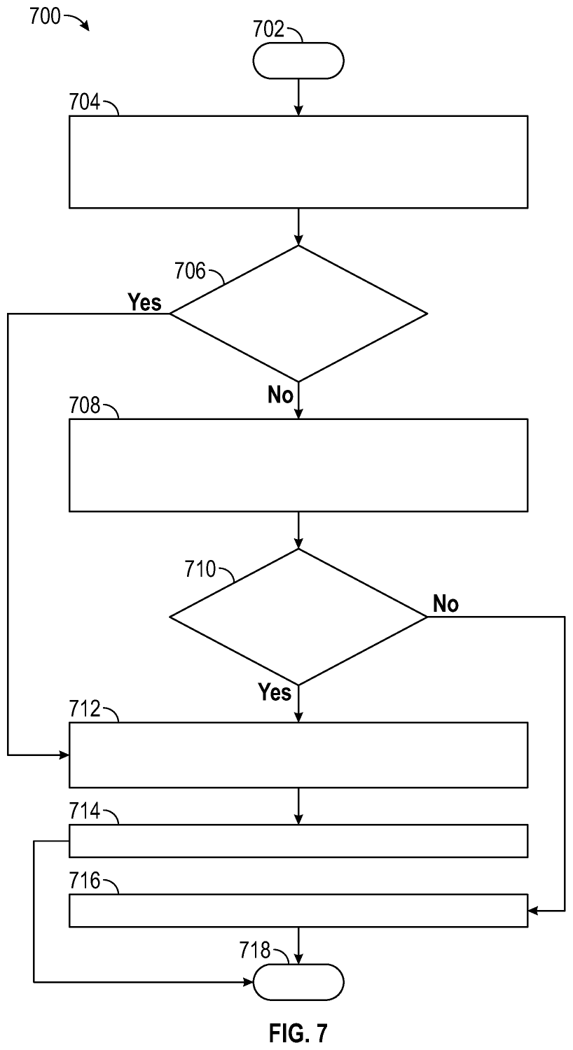

Returning to box 606, if the report is an accurate report, the method proceeds to box 610. In box 610, a check is made to determine whether there was an issue determining the lane marker(s). In box 612, a decision is made based on the results of the check in box 610. If there was a lane mark detection issue, the method proceeds to box 614. In box 614, the method checks for related conditions and outputs lane detection issues. Details of the checks performed in box 614 are discussed with respect to FIG. 7. From box 614, the method proceeds to box 636 where the method ends.

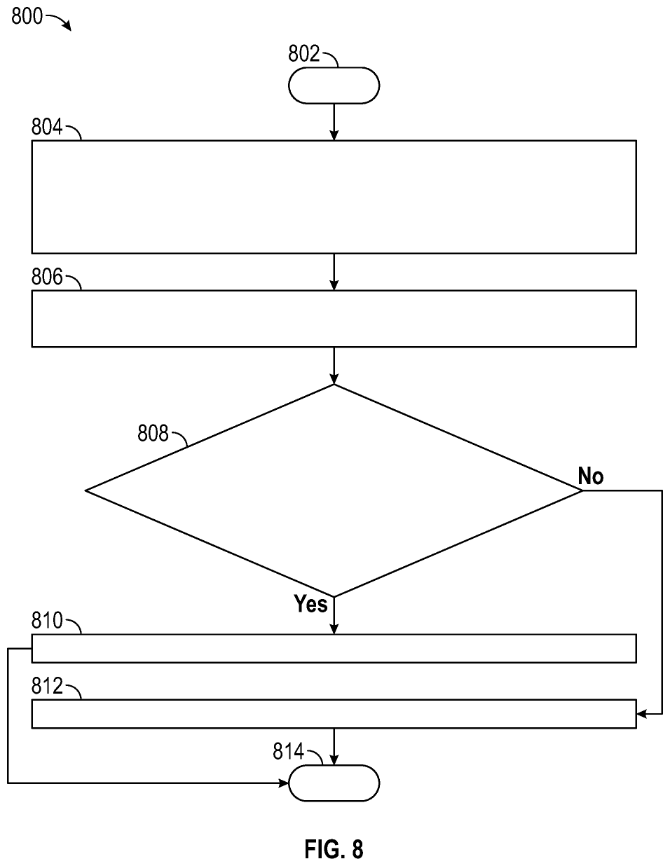

Returning to box 612, if there is no lane mark detection issue, the method proceeds to box 616. In box 616, a check is made to determine whether there are any path planning issues. In box 618, a decision is made based on the results of box 616. If there is a path planning issue, the method proceeds to box 620. In box 620, the path planning issue is identified and output. Details of the method performed in box 620 are discussed with respect to FIG. 8. From box 620, the method proceeds to box 636, where the method ends.

Returning to box 618, if there is no path planning issue, the method proceeds to box 622. In box 622, a determination is made whether the error occurred during a selected time frame shortly after engagement of the cruise control. Such error can be related to a transition from human control of the vehicle to vehicular control of the vehicle. If the error occurred within the selected time frame, the method proceeds to box 624. In box 624, the records are review for conditions just before engaging the cruise control, such as the proximity of the vehicle to the lane marker at the transition, whether the vehicle was on a road, etc. Such conditions are provided as output. The method then proceeds to box 636, wherein the method ends.

Returning to box 622, if the error occurred after the selected time frame, the method proceeds to box 626. In box 626, records are reviewed to determine if the vehicle was on a curved road. If the vehicle was on a curved road when the lane touch occurred, the method proceeds to box 628. In box 628, the records are reviewed for road entrance or road exit conditions or curve conditions, the curve control issues are output. The method then proceeds to box 636 where the method ends.

Returning to box 626, if the vehicle was not on a curved road, the method proceeds to box 630. In box 630, the records are reviewed to determine if the vehicle was acting in response to a lane change on demand (LCOD) command. If the vehicle was responding to a LCOD, the method proceeds to box 632. In box 632, the records are checked for related LCOD conditions. The LCOD related control issues are output. The method then proceeds to box 636 where the method ends.

Returning to box 630, if the vehicle was not responding to LCOD, the method proceeds to box 634. In box 634, the records are reviewed to look for any related reaction conditions. These possible related actions are output. The method then proceeds to box 636 wherein the method ends.

FIG. 7 shows a flowchart 700 for identifying a lane mark detection issue, in an illustrative embodiment. The method starts at box 702. In box 704, variables for lane mark determination before a lane touch are input and reviewed. Such variables include, but are not limited to, an Alert_Lane_Uncertain, Left_lane-quality indicator, right lane quality indicator, a map quality, etc.

In box 706, a decision is made based on the Alert_Lane_Uncertain variable. If Alert_Lane_Uncertain is ‘True’ (i.e., if the lane detection system indicates that it is uncertain about its detection of the lane marker), the method proceeds to box 712. Otherwise, the method proceeds to box 708. In box 708, a slide window is used to calculate a moving average value for lane qualities for the left lane marker and right lane marker and based on data from a camera and a map.

In box 710, a decision is made based on the lane quality. If the lane quality is low or poor, the method proceeds to box 712. In box 712, a review of the records is made for related conditions, such as a lane merge or lane split, an occurrence of road construction, a curved road, a lane change, etc. In box 714, the lane detection issue is output with the related conditions. The method then proceeds to box 718 where the method ends. Returning to box 710, if the lane quality is good, the method proceeds to box 716. In box 716, an output is generated to indicate that there is no lane mark issue.

FIG. 8 shows a flowchart 800 of a method for identifying path planning issues. The method starts at box 802. In box 804, the values of path planning variables and therefore values obtained within a selected time before the lane touch event are reviewed. Such path planning variables include, but are not limited to, distance_to_target_path(t). In an illustrative embodiment, the time period includes a time period from three seconds before the lane touch to one second before the lane touch. A negative value of distance_to_target_path>0 means the vehicle is moving to the left and a positive value means the vehicle is moving to the right.

In box 806, a minimum value for the distance to target path during the selected time is determined and a maximum value of the distance to target path during the selected time is determined.

In box 808, a path planning error condition is checked. As an example, the condition is whether the minimum value is within 40 centimeters of the left lane and a left lane touch is received or the maximum value is within 40 centimeters of the right lane marker and a right lane touch is received, and the road is not curved and a lane change is not specified. When this is true, the method proceeds to box 810. In box 810, the path planning issue is output. The method the proceeds to box 814, where the method ends.

Returning to box 808, if the condition is false, the method proceeds to box 812. In box 812, an output is generated to indicate that there is no path planning issue. From box 812, the method proceeds to box 814, where the method ends.

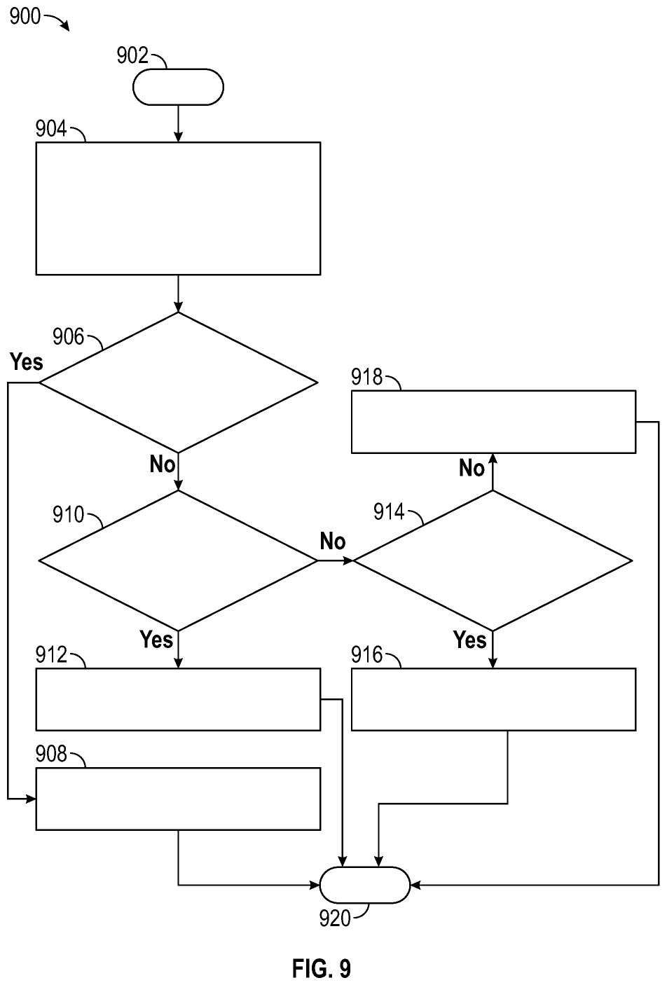

FIG. 9 shows a flowchart 900 of a method for identifying lane change issues. The method starts at box 902. In box 904, the values of lane change variables obtained within a selected time before the lane touch event are input. Such lane change variables include, but are not limited to, a lane change status and a lane offset.

In box 906, the records are reviewed to determine whether a lane change was aborted before the lane touch event occurred. If the lane change was aborted before the lane touch occurred, the method proceeds to box 908. In box 908, the output is generated to indicate a late abort of lane change occurred. The method the proceeds to box 920, where the method ends.

Returning to box 906, if the lane was not aborted or was aborted after a lane touch event, the method proceeds to box 910. In box 910, a review of the records is made to determine if another lane marker is touched, such as a next lane marker of the next lane. If the next lane marker is touched, the method proceeds to box 912. In box 912, the output is generated to indicate an oversteering during lane change. The method the proceeds to box 920 where the method ends.

Returning to box 910, if the next lane marker is not touched, the method proceeds to box 914. In box 914, the records are reviewed to determine if the nearest lane is touched again after then lane touch event. If the nearest lane is touched again, the method proceeds to box 916. In box 916, output is generated to indicate that an overadjustment is made of the lane change. The method then proceeds to box 920 where the method ends.

Returning to box 914, if the nearest lane is not touched after the original lane touch event, the method proceeds to box 918. In box 918, an output is generated to indicate no lane change issues. From box 918, the method proceeds to box 920, wherein the method ends.

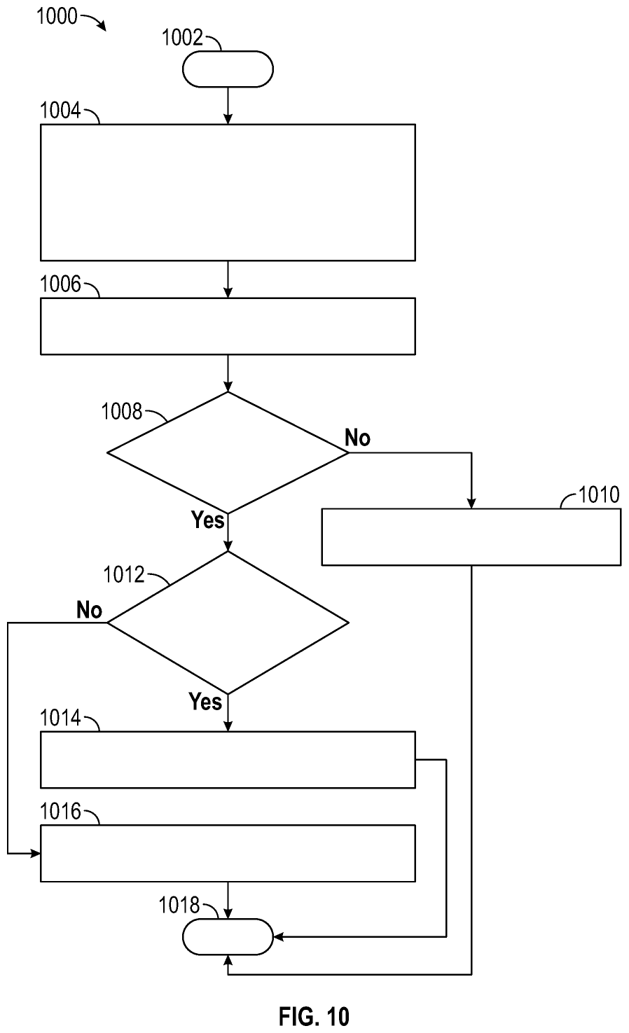

FIG. 10 shows a flowchart 1000 of a method for identifying straight road issues. The method starts in box 1002. In box 1004, the steering variable values that occur within a time window before the lane touch event are input. Such steering variable values can include, but are not limited to, a steering angle, a lane offset, etc. In an illustrative embodiment, the time window can include from about 2 seconds before the lane touch event to about 1 second before the lane touch event.

In box 1006, an average steering angle value A is calculated within the time window. In box 1008, the average steering angle is compared to a threshold steering angle value. If the absolute value of the average steering angle is less than or equal to the threshold, the method proceeds to box 1010. In box 1010, an output is generated to indicate that the steering was unreactive to the lane touch event. From box 1010, the method proceeds to box 1018 where the method ends.

Returning to box 1008, if the absolute value of the average steering angle is greater than the threshold, the method proceeds to box 1012. In box 1012, the records are reviewed to determine if the steering angle directed the vehicle towards the lane that was touched. If the steering was toward the lane that was touched, the method proceeds to box 1014. Otherwise, the method proceeds to box 1016.

In box 1014, output is generated to indicate that the steering performed an incorrect reaction to the lane touch. In box 1016, output is generated to indicate that the steering was too late or too small to react to the lane touch event. From either box 1014 or box 1016, the method proceeds to box 1018 where the method ends.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a driving system for a vehicle, comprising:
obtaining an external parameter indicative of a lane marking using a first sensor during a time period in which an automated driving program is being operated at the vehicle;
obtaining an internal parameter of the vehicle using a second sensor during the time period;
detecting a lane touch event occurring during the time period;
determining, at a processor, an error occurring at the driving system resulting in the lane touch event based on the internal parameter and the external parameter;
identify, at the processor, a failure domain of the driving system in which the error occurs; and
changing a design of a program of the driving system related to the failure domain.

2. The method of claim 1, wherein each of the internal parameter and the external parameter includes a time series of data obtained over a time interval.

3. The method of claim 1, wherein the failure domain is at least one of: (i) a vehicle sensing domain; (ii) a path planning domain; (iii) a vehicle control domain; and (iv) a reporting domain.

4. The method of claim 3, wherein an error in the vehicle sensing domain includes an error in detecting a lane marking.

5. The method of claim 3, further comprising determining an error in the path planning domain when a lane touch occurs by comparing a difference between a planned path of the vehicle to an actual path of the vehicle to a threshold value.

6. The method of claim 3, further comprising determining a lane change issue due to one of: (i) a late abort of a lane change; (ii) oversteering during a lane change; and (iii) an over adjustment for the lane change.

7. The method of claim 3, further comprising determining a responsiveness of the driving system to the lane touch event.

8. A driving system for a vehicle, comprising:
a first sensor configured to obtain an external parameter indicative of a lane marking during a time period in which an automated driving program is being operated at the vehicle;
a second sensor configured to obtain an internal parameter of the vehicle during the time period;
a processor configured to:
detect a lane touch event occurring during the time period;
determine an error occurring in the driving system resulting in the lane touch event based on the internal parameter and the external parameter;
identify a failure domain of the driving system in which the error occurs; and
change a design of a program of the driving system related to the failure domain.

9. The driving system of claim 8, wherein each of the internal parameter and the external parameter includes a time series of data obtained over a time interval.

10. The driving system of claim 8, wherein the failure domain is at least one of: (i) a vehicle sensing domain; (ii) a path planning domain; (iii) a vehicle control domain; and (iv) a reporting domain.

11. The driving system of claim 10, wherein an error in the vehicle sensing domain that includes an error in detecting a lane marking.

12. The driving system of claim 10, wherein the processor is further configured to determine an error in the path planning domain when a lane touch occurs by comparing a difference between a planned path of the vehicle to an actual path of the vehicle to a threshold value.

13. The driving system of claim 10, wherein the processor is further configured to determine a lane change issue due to one of: (i) a late abort of a lane change; (ii) oversteering during a lane change; and (iii) an over adjustment for the lane change.

14. The driving system of claim 10, wherein the processor is further configured to determine a responsiveness of the driving system to the lane touch event.

15. A system for designing a driving system for a vehicle, comprising:
a first sensor configured to obtain an external parameter indicative of a lane marking during a time period in which an automated driving program is being operated at the vehicle;
a second sensor configured to obtain an internal parameter of the vehicle during the time period;
a processor configured to:
detect a lane touch event occurring during the time period;
determine an error occurring in the driving system resulting in the lane touch event based on the internal parameter and the external parameter;
identify a failure domain of the driving system in which the error occurs; and
change a design of a program of the driving system related to the failure domain.

16. The system of claim 15, wherein the failure domain is at least one of: (i) a vehicle sensing domain; (ii) a path planning domain; (iii) a vehicle control domain; and (iv) a reporting domain.

17. The system of claim 16, wherein an error in the vehicle sensing domain that includes an error in detecting a lane marking.

18. The system of claim 16, wherein the processor is further configured to determine an error in the path planning domain when a lane touch occurs by comparing a difference between a planned path of the vehicle to an actual path of the vehicle to a threshold value.

19. The system of claim 16, wherein the processor is further configured to determine a lane change issue due to one of: (i) a late abort of a lane change; (ii) oversteering during a lane change; and (iii) an over adjustment for the lane change.

20. The system of claim 16, wherein the processor is further configured to determine a responsiveness of the driving system to the lane touch event.
